(19) United States
(12) Patent Application Publication
(10) Pub. No.: US 2026/0106400 A1
(43) Pub. Date: Apr. 16, 2026

(54) HIGH VOLTAGE CONDCUTOR ASSEMBLY FOR AN ELECTRICAL DEVICE

(71) Applicant: TE Connectivity Solutions GmbH, Schaffhausen (CH)

(72) Inventors: Mithun Hebbar, Bangalore (IN); Matthew Bryan Hitchcock, Hershey, PA (US)

(21) Appl. No.: 18/956,052

(22) Filed: Nov. 22, 2024

(30) Foreign Application Priority Data
Oct. 10, 2024 (IN) 202441076870

(51) Int. Cl. H01R 13/512; B60L 53/16; H01R 4/34

(52) U.S. Cl. CPC H01R 13/512; B60L 53/16; H01R 4/34; H01R 2201/26

(57) ABSTRACT

A high voltage conductor assembly includes a high voltage conductor having a conductor fastening end with an opening receiving a fastener to connect the conductor fastening end to a power terminal of a high voltage electrical device. The high voltage conductor assembly includes a conductor retainer having a dielectric body with a retainer cavity configured to receive a portion of the high voltage conductor. The conductor retainer includes a retainer flange configured to be received in a retainer pocket of a housing of the high voltage electrical device to position the conductor retainer relative to the high voltage electrical device. The retainer flange includes a latch element latchably coupled to the housing of the high voltage electrical device. The conductor retainer independently holds a position of the conductor fastening end of the high voltage conductor relative to the power terminal for contact free assembly of the high voltage conductor to the power terminal.

### CROSS REFERENCE TO RELATED APPLICATIONS

This application claims benefit to IN Application No. 202441076870, filed 10 Oct. 2024, the subject matter of which is herein incorporated by reference in its entirety.

### BACKGROUND OF THE INVENTION

The subject matter herein relates generally to high voltage electrical devices.

High voltage electrical devices are used to electrically connect are used to power systems. High voltage electrical devices may be used in automotive systems, aeronautical systems, industrial systems, network or other data communication systems, or another applications. For example, electric vehicles (EV) and hybrid electric vehicles (HEV) include battery systems for operating the vehicles and high voltage electrical devices are incorporated into the battery systems. For example, the battery systems are charged by a vehicle charging system. The system includes high voltage conductors that are connected between the various components of the system. Connecting the high voltage conductors to the components may be time consuming and/or difficult. For example, the high voltage conductors may be rigid and difficult to hold in position during connection to other components. For example, holding the end of the high voltage conductor as well as the fastener during assembly may be difficult.

A need remains for a method and device for holding high voltage conductors during assembly in a high voltage electrical device.

### BRIEF DESCRIPTION OF THE INVENTION

In one embodiment, a high voltage conductor assembly is provided and includes a high voltage conductor which includes a conductor fastening end that has an opening configured to receive a fastener to connect the conductor fastening end to a power terminal of a high voltage electrical device. The high voltage conductor assembly includes a conductor retainer that includes a dielectric body that has a retainer cavity configured to receive a portion of the high voltage conductor. The conductor retainer includes a retainer flange configured to be received in a retainer pocket of a housing of the high voltage electrical device to position the conductor retainer relative to the high voltage electrical device. The retainer flange includes a latch element configured to be latchably coupled to the housing of the high voltage electrical device to secure the retainer flange in the retainer pocket. The conductor retainer is configured to independently hold a position of the conductor fastening end of the high voltage conductor relative to the power terminal for contact free assembly of the high voltage conductor to the power terminal.

In another embodiment, a high voltage electrical device is provided and includes a housing that extends between a front and a rear. The housing includes a terminal channel extending between the front and the rear. The housing includes a terminal pocket at the rear open to the terminal channel. The housing includes a retainer pocket at the rear open to the terminal pocket. The housing includes a housing latch in the retainer pocket. The high voltage electrical device includes a power terminal received in the terminal channel. The power terminal includes a mating end and a fastening end. The mating end is configured to be mated with a mating power contact. The fastening end has an opening configured to receive a fastener. The high voltage electrical device includes a high voltage conductor assembly that includes a high voltage conductor and a conductor retainer holding the high voltage conductor. The high voltage conductor includes a conductor fastening end that has an opening configured to be aligned with the opening in the fastening end of the power terminal to receive the fastener to connect the conductor fastening end to the fastening end of the power terminal. The conductor retainer includes a dielectric body having a retainer cavity configured to receive a portion of the high voltage conductor. The conductor retainer includes a retainer flange received in the retainer pocket of the housing to position the conductor retainer relative to the high voltage electrical device. The retainer flange includes a retainer latch configured to be latchably coupled to the housing latch to secure the retainer flange in the retainer pocket. The conductor retainer is configured to hold a position of the conductor fastening end of the high voltage conductor relative to the fastening end of the power terminal prior to the fastener connecting the high voltage conductor to the power terminal for contact free assembly of the high voltage conductor to the power terminal.

In a further embodiment, a high voltage electrical device is provided and includes a housing that extends between a front and a rear. The housing includes terminal channels extending between the front and the rear. The housing includes a terminal pocket at the rear open to the terminal channels. The housing includes a retainer pocket at the rear open to the terminal pocket. The housing includes a housing latch in the retainer pocket. The high voltage electrical device includes power terminals received in the terminal channels. Each power terminal includes a mating end and a fastening end. The mating end is configured to be mated with a mating power contact. The fastening end has an opening configured to receive a fastener. The high voltage electrical device includes a high voltage conductor assembly that includes high voltage conductors and a conductor retainer holding the high voltage conductors. Each high voltage conductor includes a conductor fastening end that has an opening configured to be aligned with the opening in the fastening end of the power terminal to receive the fastener to connect the conductor fastening end to the fastening end of the power terminal. The conductor retainer includes a dielectric body that has a retainer cavity configured to receive end portions of the high voltage conductors. The conductor retainer includes a retainer flange received in the retainer pocket of the housing to position the conductor retainer relative to the high voltage electrical device. The retainer flange includes a retainer latch configured to be latchably coupled to the housing latch to secure the retainer flange in the retainer pocket. The conductor retainer is configured to hold positions of the conductor fastening ends of the high voltage conductors relative to the fastening ends of the power terminals prior to the fasteners connecting the high voltage conductors to the power terminals for contact free assembly of the high voltage conductors to the power terminals.

### BRIEF DESCRIPTION OF THE DRAWINGS

FIG. 1 is a schematic view of a high voltage electrical device in accordance with an exemplary embodiment.

FIG. 2 is a front view of the high voltage electrical device in accordance with an exemplary embodiment.

FIG. 3 is a rear view of the high voltage electrical device in accordance with an exemplary embodiment.

FIG. 4 is a rear, exploded view of the high voltage conductor assembly in accordance with an exemplary embodiment.

FIG. 5 is a rear, assembled view of the high voltage conductor assembly in accordance with an exemplary embodiment.

FIG. 6 is a perspective view of a portion of the housing in accordance with an exemplary embodiment.

FIG. 7 is a rear perspective view of a portion of the housing in accordance with an exemplary embodiment.

FIG. 8 is an exploded view of the conductor retainer in accordance with an exemplary embodiment.

FIG. 9 is an exploded view of the high voltage conductor assembly in accordance with an exemplary embodiment.

FIG. 10 is an assembled view of the high voltage conductor assembly in accordance with an exemplary embodiment.

FIG. 11 is a perspective view of a portion of the high voltage electrical device showing the high voltage conductor assembly poised for loading into the housing in accordance with an exemplary embodiment.

FIG. 12 is a partially assembled view of a portion of the high voltage electrical device showing the high voltage conductor assembly partially loaded into the housing in accordance with an exemplary embodiment.

FIG. 13 is an assembled view of a portion of the high voltage electrical device showing the high voltage conductor assembly fully loaded into the housing in accordance with an exemplary embodiment.

FIG. 14 is a partially assembled view of a portion of the high voltage electrical device showing the fasteners poised for coupling to the high voltage conductors in accordance with an exemplary embodiment.

FIG. 15 is an assembled view of a portion of the high voltage electrical device showing the fasteners secured to the high voltage conductors in accordance with an exemplary embodiment.

### DETAILED DESCRIPTION OF THE INVENTION

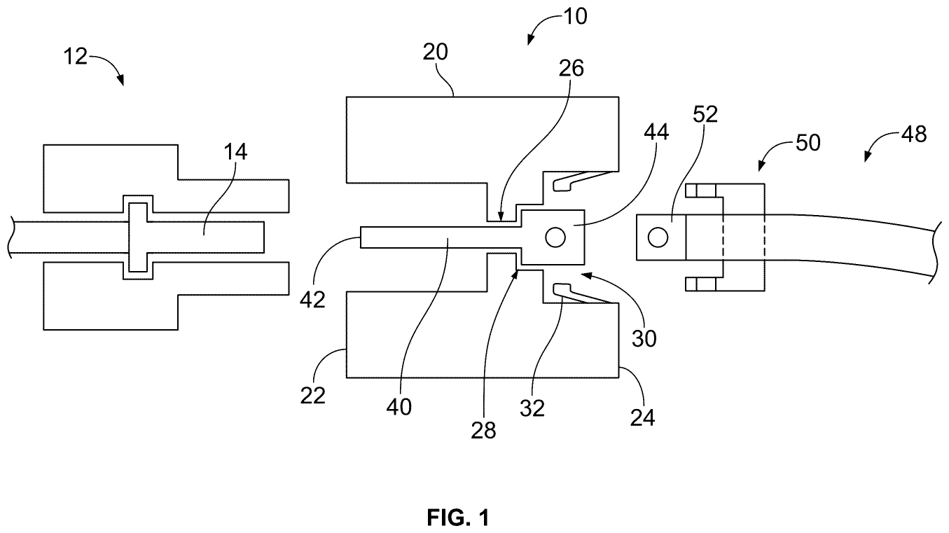

FIG. 1 is a schematic view of a high voltage electrical device 10 in accordance with an exemplary embodiment. The high voltage electrical device 10 is used to provide a high voltage power connection between electrical components, such as for a high voltage power supply to one or more components. The high voltage electrical device 10 may be used in various applications, such as an automotive application, an aeronautical application, an industrial application, a network or other data communication application, or another type of application. In various embodiments, the high voltage electrical device 10 may be used as part of a battery system, such as a battery system for an electric vehicle. For example, the high voltage electrical device 10 may be used as part of a charging component for an electric vehicle.

In an exemplary embodiment, the high voltage electrical device 10 is configured to be mated with a mating electrical device 12. For example, the high voltage electrical device 10 may be electrically connected to a mating power terminal 14 of the mating electrical device 12. The mating electrical device 12 may be a plug connector or a receptacle connector. The mating electrical device 12 may be coupled to a conductor, such as a high voltage cable or a high voltage busbar.

In an exemplary embodiment, the high voltage electrical device 10 incorporates a conductor retainer 50 to aid in assembly of the high voltage electrical device 10 to allow for contact free assembly (for example, hands free or free from holding by another, separate holding element) of various components of the high voltage electrical device 10 to ease assembly and reduce assembly time. For example, the conductor retainer 50 is used to hold one or more high voltage conductors 52. In various embodiments, the high voltage conductors 52 may be high voltage cables. In other various embodiments, the high voltage conductors 52 may be high voltage busbars or other types of high voltage conductors.

The high voltage electrical device 10 includes a housing 20 extending between a front 22 and a rear 24. The housing 20 includes a terminal channel 26 extending between the front 22 and the rear 24. The housing 20 includes a terminal pocket 28 at the rear 24 open to the terminal channel 26. The housing 20 includes a retainer pocket 30 at the rear 24 open to the terminal pocket 28 configured to receive the conductor retainer 50. The housing 20 includes a housing latch 32 in the retainer pocket 30 configured to secure the conductor retainer 50 in the retainer pocket 30.

The high voltage electrical device 10 includes a power terminal 40 received in the terminal channel 26. The power terminal 40 includes a mating end 42 and a fastening end 44. The mating end 42 is configured to be mated with the mating power terminal 14. The fastening end 44 is configured to be electrically connected to the corresponding high voltage conductor 52 during assembly, such as using a threaded fastener.

The high voltage electrical device 10 includes a high voltage conductor assembly 48 including the high voltage conductor(s) 52 and the conductor retainer 50 holding the high voltage conductor(s) 52. The conductor retainer 50 includes is configured to be received in the retainer pocket 30 of the housing 20 to position the conductor retainer 50 relative to the high voltage electrical device 10. The conductor retainer 50 is configured to be secured in the retainer pocket 30 by the housing latch 32. The conductor retainer 50 is configured to hold a position of the high voltage conductor 52 relative to the fastening end 44 of the power terminal 40 during assembly, such as prior to the fastener connecting the high voltage conductor 52 to the power terminal 40 for contact free assembly of the high voltage conductor 52 to the power terminal 40.

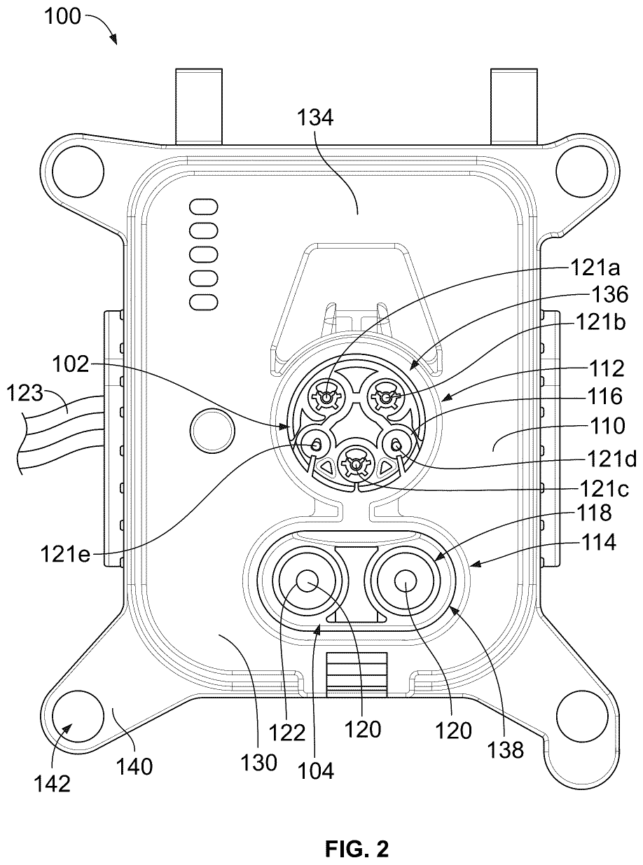

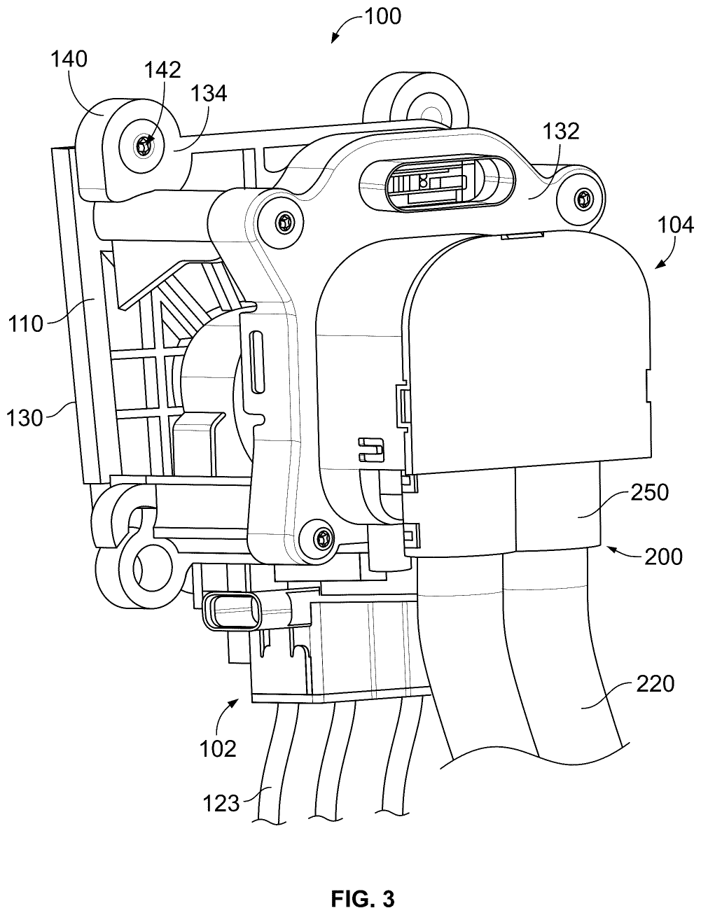

FIG. 2 is a front view of the high voltage electrical device 10 in accordance with an exemplary embodiment. FIG. 3 is a rear view of the high voltage electrical device 10 in accordance with an exemplary embodiment. In the illustrated embodiment, the high voltage electrical device 10 includes a charging inlet assembly 100. In an exemplary embodiment, the charging inlet assembly 100 includes an AC charging module 102 and a DC charging module 104. In various embodiments, the AC charging module 102 and the DC charging module 104 are at separate positions and use separate charging pins. In other various embodiments, the AC charging module 102 and the DC charging module 104 are at the same location and use the same charging pins.

The charging inlet assembly 100 is used as a charging inlet for a vehicle, such as an electric vehicle (EV) or a plug-in hybrid electric vehicle (HEV). The charging inlet assembly 100 is configured for mating reception with a charging connector (not shown). In various embodiments, the charging inlet assembly 100 is configured for mating with a DC fast charging connector, such as the SAE combo CCS charging connector, in addition to AC charging connectors, such as the SAE J1772 charging connector. In various embodiments, the charging inlet assembly 100 has a CCS1 (5 pin) configuration. In other various embodiments, the charging inlet assembly 100 may have a CCS2 (7 pin) configuration. In an exemplary embodiment, the charging inlet assembly 100 is configured to be mated with an NACS charging plug and has an NACS J3400 interface including two charging pins, a pilot pin, a control pin and a ground pin. Other standard inlet configurations may be used in alternative embodiments.

The charging inlet assembly 100 includes a housing 110 configured to be mounted in the vehicle. The housing 110 holds the AC charging module 102 and the DC charging module 104 for mating with the charging connector. In various embodiments, the AC charging module 102 and/or the DC charging module 104 are removable from the housing 110. For example, the charging modules 102 may be coupled to the housing 110 using latches, fasteners, clips, or other securing means. The charging modules 102, 104 may be removable from the housing 110 to separate components of the charging modules 102, 104 (for example, charging pins, cables, circuit boards, and the like) from the housing 110, such as for repair and/or replacement of the charging module components or other components of the charging inlet assembly 100.

In an exemplary embodiment, the housing 110 includes an AC section 112 that receives the AC charging module 102 and a DC section 114 that receives the DC charging module 104. The AC section 112 is configured for mating with an AC charging connector or an AC section of the charging connector. The DC section 114 is configured for mating with a DC charging connector or a DC section of the charging connector. The AC section 112 includes AC terminal channels 116. The DC section 114 includes DC terminal channels 118. The charging inlet assembly 100 includes power terminals (for example, AC power terminals 121 and/or DC power terminals 120) held by the housing 110, such as in the corresponding terminal channels 116, 118.

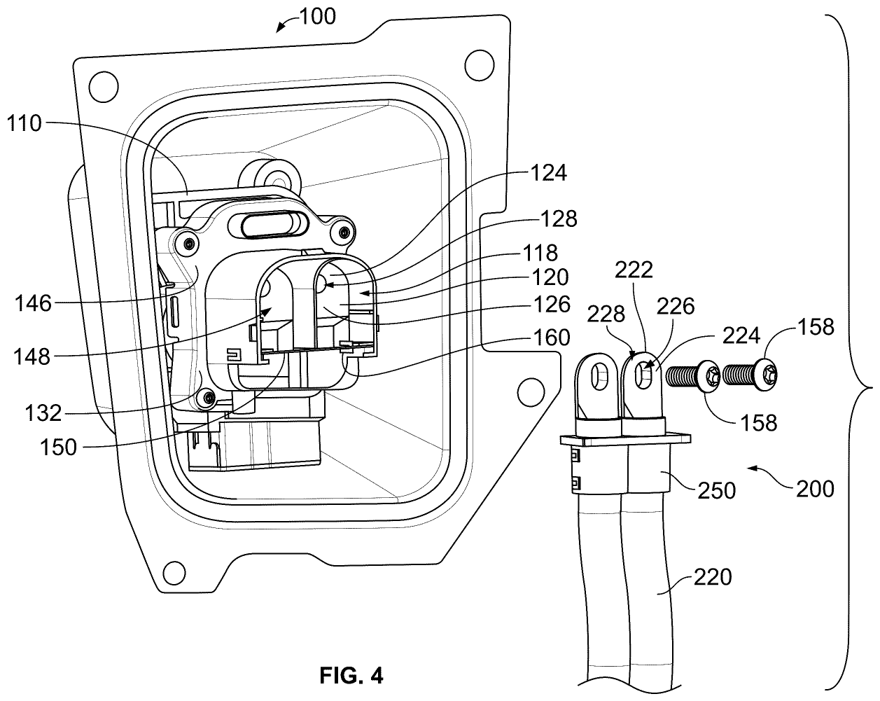

In an exemplary embodiment, the charging inlet assembly 100 includes DC terminals 120 at the DC section 114. The DC terminals 120 may be referred to hereinafter as “DC power terminals 120” or simply “power terminals 120”. The power terminals 120 are held by the housing 110. The power terminals 120 are received in corresponding terminal channels 118. In various embodiments, the power terminals 120 may be part of the DC charging module 104 that is coupled to the housing 110. In the illustrated embodiment, two power terminals 120 are provided. However, greater or fewer power terminals 120 may be provided in alternative embodiments. In an exemplary embodiment, the power terminals 120 include pins at mating ends 122 of the power terminals 120. The mating ends 122 may include sockets or other types of mating ends in alternative embodiments. High voltage conductors 220 are terminated to fastening ends 124 (shown in FIG. 4) of the power terminals 120 and extend from the charging inlet assembly 100 to another component of the vehicle, such as the battery system of the vehicle.

In an exemplary embodiment, the DC section 114 of the charging inlet assembly 100 defines a high-voltage connector configured to be coupled to the high-voltage portion of the charging connector. The high-voltage connector (for example, the power terminals 120 and the high voltage conductors 220) is configured to be coupled to other components in the system, such as the battery and/or the battery distribution unit of the vehicle. The high-voltage connector is used for fast charging of the battery. The high-voltage connector may be a socket connector configured to receive the charging plug. Seals may be provided at the interface of the high-voltage connector.

In an exemplary embodiment, the AC section 112 includes AC terminals 121 received in the corresponding AC terminal channels 116. In the illustrated embodiment, five AC terminals 121 are provided, including a first AC charging terminal 121a, a second AC charging terminal 121b, a ground terminal 121c, a proximity terminal 121d, and a pilot terminal 121e. Optionally, the AC terminals 121 may be different sized terminals. In an exemplary embodiment, the AC terminals 121 include pins at mating ends of the AC terminals 121. AC conductors 123 are terminated to the AC terminals 121 and extend from the charging inlet assembly 100 to another component of the vehicle, such as the battery system of the vehicle. The AC conductors 123 may be cables, busbars, contacts, or other types of conductors.

In an exemplary embodiment, the AC section 112 of the charging inlet assembly 100 defines a low-voltage connector configured to be coupled to the low-voltage portion of the charging connectors. The low-voltage connector (for example, the AC terminals 121 and the AC conductors 123) is configured to be coupled to other components in the system, such as a battery distribution unit, to control charging of the vehicle. The low-voltage connector may transmit/receive signals relating to charging, such as status of connection, status of charge, voltage of charge, and the like. The low-voltage connector may be a socket connector configured to receive the charging plug. Seals may be provided at the interface of the low-voltage connector.

The housing 110 includes a front 130 and a rear 132. The front 130 of the housing 110 faces outward and is presented to the operator to connect the charging connector. The rear 132 faces the interior of the vehicle and is generally inaccessible without removing the housing 110 from the vehicle. In an exemplary embodiment, the housing 110 includes a panel 134 at the front 130. In an exemplary embodiment, an AC socket 136 is formed in the panel 134 at the AC section 112 and a DC socket 138 is formed in the panel 134 at the DC section 114. The AC socket 136 incudes a space around the AC terminals 121 that receives the charging connector. During charging, the AC charging connector is plugged into the AC socket 136 to electrically connect to the AC terminals 121. The DC socket 138 includes a space around the power terminals 120 that receive the charging connector. The DC charging connector is configured to be plugged into the DC socket 138. During charging, the DC charging connector is plugged into the DC socket 138 to electrically connect to the power terminals 120. The panel 134 may surround the AC socket 136 and the DC socket 138 at the front 130.

In an exemplary embodiment, the housing 110 includes mounting tabs 140 used for mounting the housing 110 to the vehicle. The mounting tabs 140 have openings 142 that receive fasteners (not shown) to secure the charging inlet assembly 100 to the vehicle. Other types of mounting features may be used to secure the charging inlet assembly 100 to the vehicle. In various embodiments, the charging inlet assembly 100 may include a mounting flange (not shown) coupled to the front of the housing 110 for mounting the charging inlet assembly 100 to the vehicle. The housing 110 and/or the mounting flange may include a seal (not shown) to seal the charging inlet assembly 100 to the vehicle. In various embodiments, the charging inlet assembly 100 may include a terminal cover (not shown) at the front of the housing 110 to cover portions of the housing 110, such as the DC section 114 and/or the AC section 112. The housing 110 may include one or more rear covers at the rear of the housing 110 to close access to the rear of the housing 110. The cover(s) may be clipped or latched onto the main part of the housing 110, such as using clips or latches. Other types of securing features, such as fasteners may be used in alternative embodiments.

In an exemplary embodiment, the charging inlet assembly 100 of the high voltage electrical device 10 includes a high voltage conductor assembly 200 including a conductor retainer 250 holding the high voltage conductor(s) 220. The conductor retainer 250 is coupled to the rear 132 of the housing 110. The high voltage conductors 220 extend from the rear of the housing 110. The conductor retainer 250 is configured to hold positions of the high voltage conductors 220 relative to the power terminals 120 during assembly, such as prior to fasteners connecting the high voltage conductors 220 to the power terminals 120 for contact free assembly of the high voltage conductors 220 to the power terminals 120.

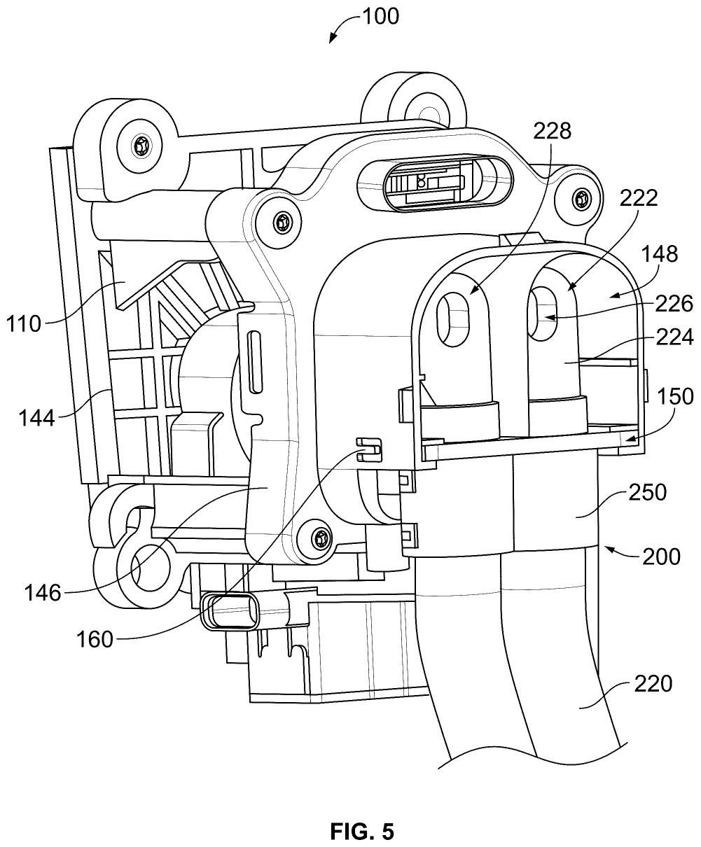

FIG. 4 is a rear, exploded view of the high voltage conductor assembly 200 in accordance with an exemplary embodiment. FIG. 5 is a rear, assembled view of the high voltage conductor assembly 200 in accordance with an exemplary embodiment. The high voltage conductor assembly 200 includes the conductor retainer 250 and the high voltage conductors 220. The high voltage conductor assembly 200 is configured to be coupled to the power terminals 120 at the rear 132 of the housing 110.

In the illustrated embodiment, the high voltage conductor assembly 200 includes a pair of the high voltage conductors 220. Greater or fewer high voltage conductors 220 may be provided in alternative embodiments. The high voltage conductors 220 may be routed along parallel paths between the charging inlet assembly 100 and another component of the vehicle. The high voltage conductors 220 may be generally rigid and retain shape when assembled within the vehicle. Each high voltage conductor 220 includes a conductor fastening end 222 extending from the jacket and configured to be terminated to the corresponding power terminal 120. In an exemplary embodiment, the conductor fastening end 222 includes a pad 224 having an opening 226 configured to receive a fastener 158. The fastener 158 may be a threaded fastener such as a threaded bolt configured to threadably couple the high voltage conductor 220 to the power terminal 120.

In an exemplary embodiment, the high voltage conductor 220 is a high voltage cable having a bolt connector 228 at the conductor fastening end 222. The bolt connector 228 includes the pad 224. The high voltage conductor 220 may have an outer jacket extending the length of the high voltage conductor 220. The high voltage cable may have a cylindrical cross-section. The high voltage cable may include bends along the length of the high voltage cable. The high voltage cable may be a stranded cable manufactured from a plurality of cable strands or wire strands that are twisted along the length of the high voltage cable. In other embodiments, the high voltage cable may be a solid-core cable manufactured from a metal, such as copper or aluminum. The high voltage cable may be an extruded cable.

In another exemplary embodiment, the high voltage conductor 220 is a high voltage bus bar. The bus bar may be stamped and formed. In other various embodiments, the bus bar may be extruded. The bus bar may have bends along the length of the bus bar, such as for routing the bus bar within the vehicle. The busbar may be generally rigid and retain its shape. The bus bar may have a generally rectangular cross-section. However, the bus bar may have other shapes in alternative embodiments, such as a cylindrical cross-section.

The housing 110 of the charging inlet assembly 100 holds the power terminals 120. For example, the power terminals 120 are held in corresponding terminal channels 118. In an exemplary embodiment, the housing 110 is a multi-piece housing. For example, the housing 110 may include a front housing 144 and a rear cover 146 coupled to the front housing 144 at the rear 132. The rear cover 146 may be secured to the front housing 144 using latches, clips, fasteners or other securing features.

In an exemplary embodiment, each power terminal 120 includes a fastening end 124 opposite the mating end 122 (shown in FIG. 2). The fastening end 124 is configured to be electrically connected to the corresponding high voltage conductor 220 of the high voltage conductor assembly 200. The fastening end 124 is accessible at the rear 132 of the housing 110 for connection to the high voltage conductor 220. In an exemplary embodiment, the fastening end 124 is configured to be connected to the high voltage conductor 220 via a fastener 158, such as a threaded bolt. For example, the fastening end 124 may include a plate or pad 126 having an opening 128 configured to receive the fastener 158.

In an exemplary embodiment, the housing 110 includes a terminal pocket 148 at the rear 132 open to the terminal channels 118. The terminal pocket 148 is configured to receive a portion of the power terminal 120, such as the fastening end 124. The terminal pocket 148 is sized and shaped to receive and position the power terminal 120 relative to the housing 110. For example, the terminal pocket 148 may position the opening 128 at a predetermined position relative to the housing 110. In an exemplary embodiment, the housing 110 includes a retainer pocket 150 at the rear 132 open to the terminal pocket 148. The retainer pocket 150 is configured to receive the conductor retainer 250. The conductor retainer 250 is positioned relative to the housing 110 in the retainer pocket 150, such as to position the high voltage conductor 220 in the terminal pocket 148 for mating with the power terminal 120. In an exemplary embodiment, the housing 110 includes a housing latch 160 in the retainer pocket 150. The housing latch 160 is configured to secure the conductor retainer 250 in the retainer pocket 150.

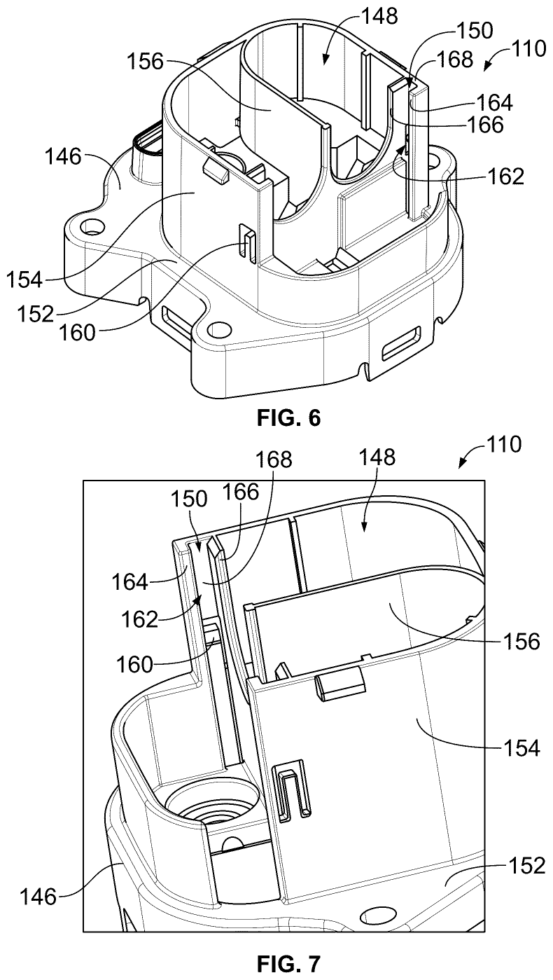

FIG. 6 is a perspective view of a portion of the housing 110 in accordance with an exemplary embodiment. FIG. 7 is a rear perspective view of a portion of the housing 110 in accordance with an exemplary embodiment. FIGS. 6 and 7 illustrate the rear cover 146 of the housing 110.

In an exemplary embodiment, the rear cover 146 includes a base wall 152 and shroud walls 154 extending from the base wall 152. The base wall 152 is configured to cover the front housing 144 when the rear cover 146 is coupled to the front housing 144. The shroud walls 154 define the terminal pocket 148 and the retainer pocket 150. In the illustrated embodiment, the retainer pocket 150 is located below the terminal pocket 148. Other locations are possible in alternative embodiments. In an exemplary embodiment, the housing latches 160 extend from the shroud walls 154 into the retainer pocket 150. The housing latches 160 may be deflectable. In an exemplary embodiment, the housing latches 160 are integral with the rear cover 146, such as being co-molded with the shroud walls 154.

In an exemplary embodiment, the rear cover 146 includes a separating wall 156 separating the terminal pocket 148 into various cavities that receive the corresponding power terminals 120 and high voltage conductors 220. The separating wall 156 electrically isolates the power terminals 120 from each other and the high voltage conductors 220 from each other. In an exemplary embodiment, the shroud walls 154 are open at the rear 132 to receive the power terminals 120 and the high voltage conductors 220 through the opening at the rear.

In an exemplary embodiment, the rear cover 146 of the housing 110 includes a guide track 162 forming the retainer pocket 150. The guide track 162 includes guide walls 164, 166 forming the retainer pocket 150. The guide track 162 is configured to receive the conductor retainer 250 between the guide walls 164, 166. For example, the guide walls 164, 166 may be located above and below the conductor retainer 250 to position the conductor retainer 250 in the retainer pocket 150. In an exemplary embodiment, the guide track 162 includes end walls 168 between the guide walls 164, 166. The end walls 168 holds a side-to-side position of the conductor retainer 250 in the guide track 162. In an exemplary embodiment, the housing latches 160 are provided along the end walls 168 and extend into the guide track 162 to interface with the conductor retainer 250. Other locations are possible in alternative embodiments.

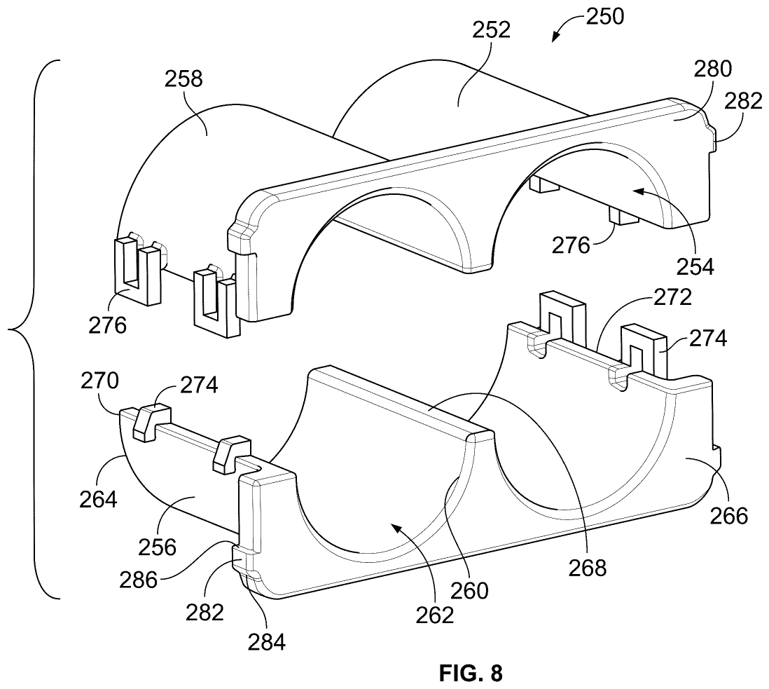

FIG. 8 is an exploded view of the conductor retainer 250 in accordance with an exemplary embodiment. The conductor retainer 250 includes a dielectric body 252 having a retainer cavity 254 configured to receive a portion of the high voltage conductor 220. The retainer cavity 254 may receive multiple high voltage conductors 220, such as a pair of the high voltage conductors 220. The conductor retainer 250 is configured to position the high voltage conductors 220 relative to each other. The conductor retainer 250 is configured to hold the high voltage conductors 220 for assembly with the housing 110 and the power terminals 120 of the charging inlet assembly 100.

In the illustrated embodiment, the conductor retainer 250 is a multipiece structure. For example, the conductor retainer 250 includes a front shell 256 and a rear shell 258. The front shell 256 is configured to be coupled to the rear shell 258 to form and the conductor retainer 250. For example, the front and rear shells 256, 258 may be secured together using clips, latches, fasteners, or other securing means. In various embodiments, the front and rear shells 256, 258 may be connected by a hinge, such as a living hinge co-molded with the front and rear shells 256, 258 such that the conductor retainer 250 may be molded in a single molding step.

In an exemplary embodiment, the front and rear shells 256, 258 are hermaphroditic including both male and female connecting elements. In an exemplary embodiment, the front and rear shells 256, 258 are identical and inverted 180°. As such, the front and rear shells 256, 258 may be molded using the same mold to reduce part numbers and reduce manufacturing costs. However, in alternative embodiments, the front and rear shells 256, 258 may include different features and/or may be sized and/or shaped differently.

In an exemplary embodiment, the conductor retainer 250 includes walls 260 forming tunnels 262 that define the retainer cavity 254 and receive the corresponding high voltage conductors 220. The conductor retainer 250 extends between a top 264 and the bottom 266. The tunnels 262 pass through the conductor retainer 250 between the top 264 and the bottom 266. In an exemplary embodiment, the conductor retainer 250 includes a dividing wall 268 between the tunnels 262. The dividing wall 268 separates the high voltage conductors 220 from each other. The dividing wall 268 may be centered between opposite first and second sides 270, 272 of the conductor retainer 250.

In an exemplary embodiment, the conductor retainer 250 includes front latching features 274 extending from the front shell 256 and one or more rear latching features 276 extending from the rear shell 258. The front latching features 274 may include latches and/or catches. For example, the front latching features 274 may include latches at the first side 270 and catches at the second side 272, or vice versa. In other various embodiments, the front latching features 274 may include both latches and catches at both the first side 270 and the second side 272. The rear latching features 276 may include latches and/or catches. For example, the rear latching features 276 may include catches at the first side 270 and latches at the second side 272, or vice versa. In other various embodiments, the rear latching features 276 may include both latches and catches at both the first side 270 and the second side 272. Other types of latching features may be used in alternative embodiments.

In an exemplary embodiment, the conductor retainer 250 includes a flange 280 at the top 264. The flange 280 may be positioned at other locations in alternative embodiments. In the illustrated embodiment, the flange 280 extends from the first side 270 and the second side 272. The flange 280 may additionally or alternatively extend from the front and the rear of the conductor retainer 250. In an exemplary embodiment, the flange 280 includes one or more retainer latches 282. For example, the retainer latches 282 may extend from the first side 270 and/or the second side 272. The retainer latches 282 are configured to interface with the housing latches 160 of the housing 110. In the illustrated embodiment, the conductor retainer 250 includes retainer latches 282 at both the first side 270 and the second side 272. In an exemplary embodiment, the retainer latch 282 is a catch protruding from the flange 280. The catch includes a ramp surface 284 and the catches surface 286. Other types of latching features may be used in alternative embodiments, such as a deflectable latch.

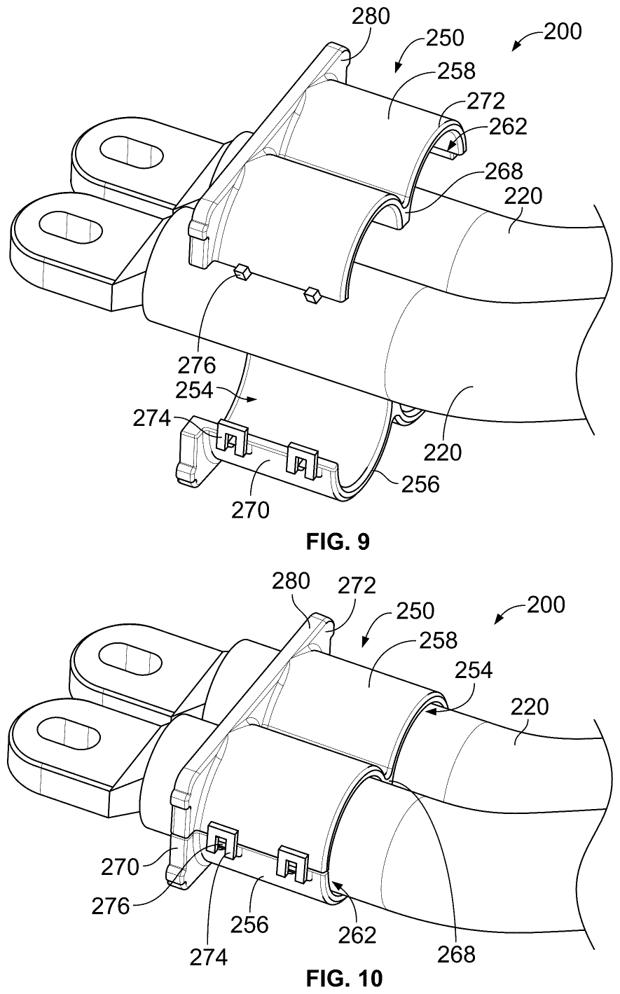

FIG. 9 is an exploded view of the high voltage conductor assembly 200 in accordance with an exemplary embodiment. FIG. 10 is an assembled view of the high voltage conductor assembly 200 in accordance with an exemplary embodiment. The high voltage conductor assembly 200 includes the high voltage conductors 220 and the conductor retainer 250 holding the high voltage conductors 220. During assembly, the conductor retainer 250 is coupled to the ends of the high voltage conductors 220 to hold the relative positions of the high voltage conductors 220.

In an exemplary embodiment, during assembly, the front and rear shells 256, 258 are coupled together from opposite sides of the high voltage conductors 220. The high voltage conductors 220 are received in the retainer cavity 254, such as in the corresponding tunnels 262. The dividing wall 268 separates the high voltage conductors 220 from each other. During assembly, the front latching features 274 are coupled to the rear latching features 276 two secure the front shell 256 to the rear shell 258. When assembled, the conductor retainer 250 holds the high voltage conductors 220 relative to each other. The flange 280 extends outward at the sides 270, 272 of the conductor retainer 250, such as for loading into the retainer pocket 150 of the housing 110.

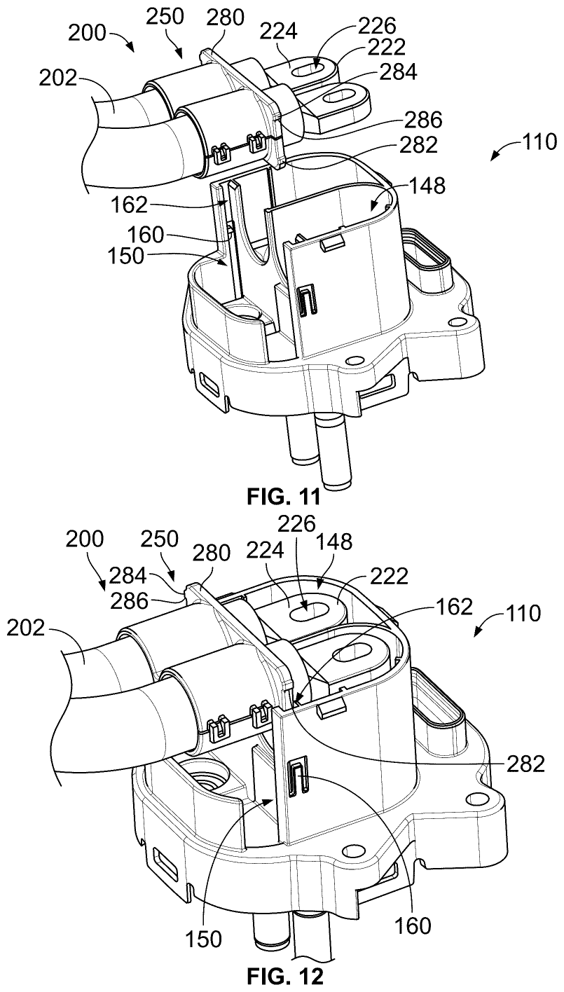

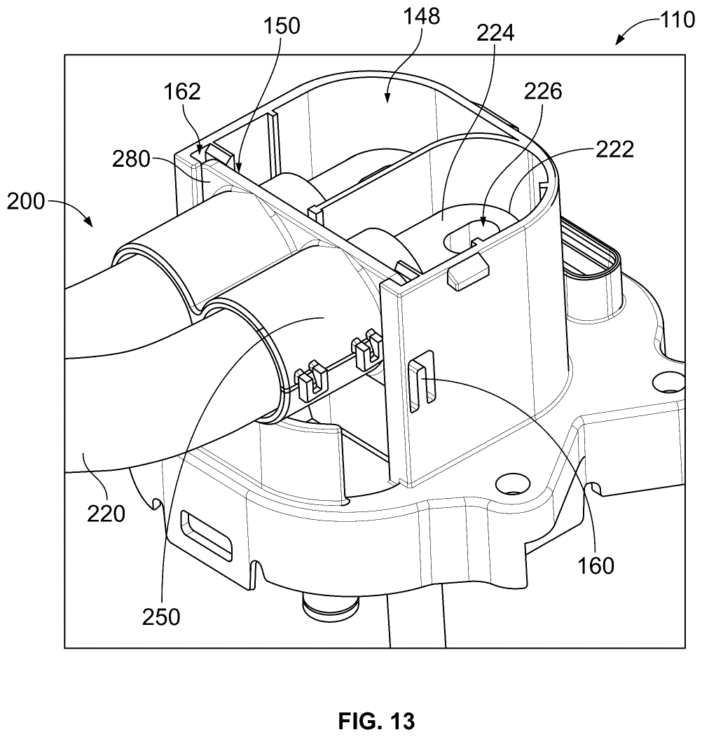

FIG. 11 is a perspective view of a portion of the high voltage electrical device 10 showing the high voltage conductor assembly 200 poised for loading into the housing 110. FIG. 12 is a partially assembled view of a portion of the high voltage electrical device 10 showing the high voltage conductor assembly 200 partially loaded into the housing 110. FIG. 13 is an assembled view of a portion of the high voltage electrical device 10 showing the high voltage conductor assembly 200 fully loaded into the housing 110.

During assembly, the high voltage conductor assembly 200 is aligned with the terminal pocket 148 and the retainer pocket 150 at the rear 132 of the housing 110. The conductor fastening ends 222 of the high voltage conductors 220 are aligned with the terminal pocket 148. For example, the openings 226 in the pads 224 of the high voltage conductor 220 are aligned with the openings 142 in the fastening ends 124 of the power terminals 120. The conductor retainer 250 is aligned with the retainer pocket 150. For example, the flange 280 is aligned with the guide track 162. During assembly, the flange 280 is loaded into the guide track 162 and slid forward in the guide track 162 to interface the retainer latches 282 with the housing latches 160. The housing latches 160 may deflect outward as the ramp surfaces 284 pass the latching ends of the housing latches 160. The latching ends of the housing latches 160 may snap inward behind the catch surfaces 286 of the retainer latches 282 two legibly secure the conductor retainer 250 in the retainer pocket 150.

During assembly, when the conductor retainer 250 is secured in the retainer pocket 150 of the housing 110, the high voltage conductors 220 are held in position relative to the housing 110 and the power terminals 120 at the rear 132 of the housing 110. For example, the installer is able to release or let go of the high voltage conductor assembly 200 and the high voltage conductors 220 remain positioned relative to the power terminals 120 for installation of the fasteners 158. As such, the conductor retainer 250 is configured to hold the positions of the conductor fastening ends 222 of the high voltage conductors 220 relative to the fastening ends 124 of the power terminals 120 prior to the fasteners 158 connecting the high voltage conductors 220 to the power terminals 120 for contact free assembly of the high voltage conductors 220 to the power terminals 120.

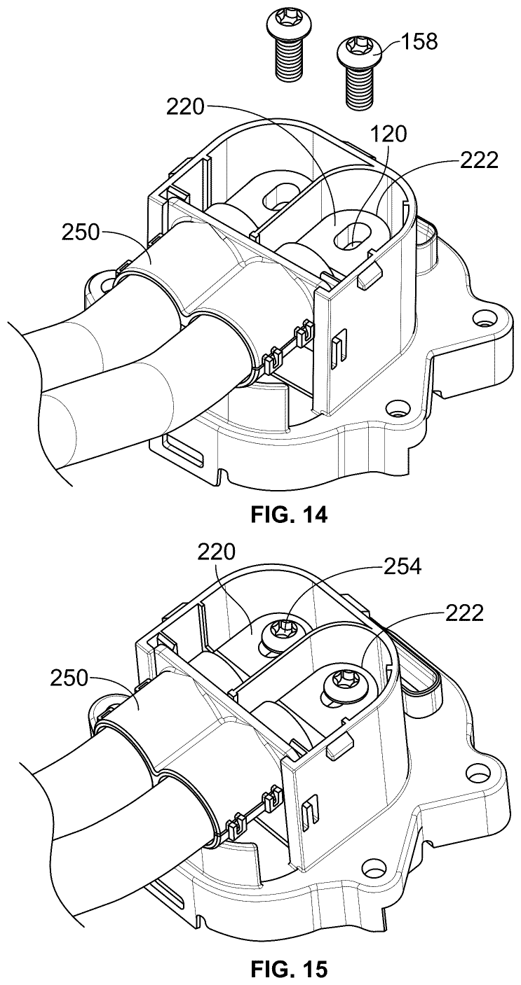

FIG. 14 is a partially assembled view of a portion of the high voltage electrical device 10 showing the fasteners 158 poised for coupling to the high voltage conductors 220. FIG. 15 is an assembled view of a portion of the high voltage electrical device 10 showing the fasteners 158 secured to the high voltage conductors 220. With the conductor retainer 250 holding the positions of the conductor fastening end 222 of the high voltage conductors 220, the installer is able to assemble the fasteners 158 without holding the high voltage conductors 220. The conductor retainer 250 allows for hands-free assembly of the high voltage conductors 220 to the power terminals 120. For example, the installer may hold the fasteners 158 with one hand and hold an installation tool, such as a drill or screwdriver with the other hand without the need to hold the high voltage conductor 220 during assembly.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means - plus-function format and are not intended to be interpreted based on 35 U.S.C. § 112(f), unless and until such claim limitations expressly use the phrase “means for” followed by a statement of function void of further structure.

What is claimed is:

1. A high voltage conductor assembly comprising:
a high voltage conductor including a conductor fastening end having an opening configured to receive a fastener to connect the conductor fastening end to a power terminal of a high voltage electrical device;
a conductor retainer including a dielectric body having a retainer cavity configured to receive a portion of the high voltage conductor, the conductor retainer including a retainer flange configured to be received in a retainer pocket of a housing of the high voltage electrical device to position the conductor retainer relative to the high voltage electrical device, the retainer flange including a latch element configured to be latchably coupled to the housing of the high voltage electrical device to secure the retainer flange in the retainer pocket;
wherein the conductor retainer is configured to independently hold a position of the conductor fastening end of the high voltage conductor relative to the power terminal for contact free assembly of the high voltage conductor to the power terminal.

2. The high voltage conductor assembly of claim 1, wherein the conductor retainer includes a front shell and a rear shell coupled to the front shell to clamp the high voltage conductor therebetween.

3. The high voltage conductor assembly of claim 1, wherein the front shell and the rear shell include hermaphroditic mating elements configured to be coupled together to secure the front shell and the rear shell.

4. The high voltage conductor assembly of claim 3, wherein the front shell and the rear shell are identical and inverted 180°to form the conductor retainer.

5. The high voltage conductor assembly of claim 3, wherein the front shell includes a latch and the rear shell includes a catch, the latch being latchably coupled to the catch to secure the front shell to the rear shell.

6. The high voltage conductor assembly of claim 1, wherein the conductor retainer includes a first side and a second side, the latch element being a first latch element at the first side, the retainer flange including a second latch element at the second side to secure both sides of the conductor retainer to the housing.

7. The high voltage conductor assembly of claim 1, wherein the high voltage conductor is a first high voltage conductor, the high voltage conductor assembly further comprising a second high voltage conductor, the conductor retainer including a separating wall extending into the retainer cavity to separate the first high voltage conductor from the second high voltage conductor in the retainer cavity, the conductor retainer holding the first high voltage conductor relative to the second high voltage conductor for hands-free assembly of both the first high voltage conductor in the second high voltage conductor to the corresponding power terminals.

8. The high voltage conductor assembly of claim 1, wherein the retainer cavity is cylindrical.

9. The high voltage conductor assembly of claim 1, wherein the high voltage conductor includes a high voltage cable and a bolt connector at the conductor fastening end.

10. The high voltage conductor assembly of claim 1, wherein the high voltage conductor includes a bus bar.

11. A high voltage electrical device comprising:
a housing extending between a front and a rear, the housing including a terminal channel extending between the front and the rear, the housing including a terminal pocket at the rear open to the terminal channel, the housing including a retainer pocket at the rear open to the terminal pocket, the housing including a housing latch in the retainer pocket;
a power terminal received in the terminal channel, the power terminal including a mating end and a fastening end, the mating end configured to be mated with a mating power contact, the fastening end having an opening configured to receive a fastener;
a high voltage conductor assembly including a high voltage conductor and a conductor retainer holding the high voltage conductor, the high voltage conductor including a conductor fastening end having an opening configured to be aligned with the opening in the fastening end of the power terminal to receive the fastener to connect the conductor fastening end to the fastening end of the power terminal, the conductor retainer includes a dielectric body having a retainer cavity configured to receive a portion of the high voltage conductor, the conductor retainer including a retainer flange received in the retainer pocket of the housing to position the conductor retainer relative to the high voltage electrical device, the retainer flange including a retainer latch configured to be latchably coupled to the housing latch to secure the retainer flange in the retainer pocket;
wherein the conductor retainer is configured to hold a position of the conductor fastening end of the high voltage conductor relative to the fastening end of the power terminal prior to the fastener connecting the high voltage conductor to the power terminal for contact free assembly of the high voltage conductor to the power terminal.

12. The high voltage electrical device of claim 11, wherein the retainer pocket includes a guide track, the retention flange received in the guide track.

13. The high voltage electrical device of claim 11, wherein the housing includes a shroud forming the retainer pocket, the conductor fastening end of the high voltage conductor extending into the retainer pocket from the conductor retainer.

14. The high voltage electrical device of claim 11, wherein the high voltage conductor assembly is rear loaded into the retainer pocket to align the opening of the conductor fastening end with the opening of the power terminal.

15. The high voltage electrical device of claim 11, wherein the conductor retainer includes a front shell and a rear shell coupled to the front shell to clamp the high voltage conductor therebetween.

16. The high voltage electrical device of claim 11, wherein the conductor retainer includes a first side and a second side, the retainer latch being a first retainer latch at the first side, the retainer flange including a second retainer latch at the second side.

17. A high voltage electrical device comprising:
a housing extending between a front and a rear, the housing including terminal channels extending between the front and the rear, the housing including a terminal pocket at the rear open to the terminal channels, the housing including a retainer pocket at the rear open to the terminal pocket, the housing including a housing latch in the retainer pocket;
power terminals received in the terminal channels, each power terminal including a mating end and a fastening end, the mating end configured to be mated with a mating power contact, the fastening end having an opening configured to receive a fastener;
a high voltage conductor assembly including high voltage conductors and a conductor retainer holding the high voltage conductors, each high voltage conductor including a conductor fastening end having an opening configured to be aligned with the opening in the fastening end of the power terminal to receive the fastener to connect the conductor fastening end to the fastening end of the power terminal, the conductor retainer includes a dielectric body having a retainer cavity configured to receive end portions of the high voltage conductors, the conductor retainer including a retainer flange received in the retainer pocket of the housing to position the conductor retainer relative to the high voltage electrical device, the retainer flange including a retainer latch configured to be latchably coupled to the housing latch to secure the retainer flange in the retainer pocket;
wherein the conductor retainer is configured to hold positions of the conductor fastening ends of the high voltage conductors relative to the fastening ends of the power terminals prior to the fasteners connecting the high voltage conductors to the power terminals for contact free assembly of the high voltage conductors to the power terminals.

18. The high voltage electrical device of claim 17, wherein the retainer pocket includes a guide track, the retention phalange received in the guide track.

19. The high voltage electrical device of claim 17, wherein the conductor retainer includes a front shell and a rear shell coupled to the front shell to clamp the high voltage conductor therebetween.

20. The high voltage electrical device of claim 17, wherein the conductor retainer includes a first side and a second side, the retainer latch being a first retainer latch at the first side, the retainer flange including a second retainer latch at the second side.
